(19) United States
(12) Patent Application Publication
(10) Pub. No.: US 2011/0000698 A1
(43) Pub. Date: Jan. 6, 2011

(54) Nano-Sized Ultrathin-Film Dielectric, Process for Producing the Same and Nano-Sized Ultrathin Film Dielectric Device

(76) Inventors: Minoru Osada, Tsukuba-shi (JP); Takayoshi Sasaki, Tsukuba-shi (JP)

Correspondence Address: WENDEROTH, LIND & PONACK, L.L.P., 1030 15th Street, N.W.,, Suite 400 East, Washington, DC, 20005-1503, US

(21) Appl. No.: 12/223,865

(22) PCT Filed: Feb. 8, 2007
(86) PCT No.: PCT/JP2007/052287

§ 371 Date: Sep. 17, 2010

(30) Foreign Application Priority Data
Feb. 13, 2006 (JP) 2006-035583

(51) Int. Cl. H01B 3/00; B32B 37/00

(52) U.S. Cl. 174/137 B; 156/60; 977/755; 977/932

(57) ABSTRACT

A nano-sized ultrathin film dielectric composed mainly of either a single nanosheet of titanium oxide obtained by exfoliating layer titanium oxide or a laminate thereof. Thus, there can be accomplished low-temperature production of a dielectric device that simultaneously realizes high dielectric constant and excellent insulating performance in nanoregions and reduces influences of substrate interface deterioration and nonstoichiometry.

### TECHNICAL FIELD

The present invention concerns a nano-sized ultrathin film dielectric which is suitable for application use in wide fields of electronic materials such as gate insulator films for transistors, capacitor components for semiconductor memory devices (DRAM) and laminate capacitors for cellular phones, and can realize high dielectric constant and excellent insulating performance, simultaneously, a process for producing the same, and a nano-sized ultrathin film dielectric device.

### BACKGROUND ART

High dielectric constant materials have been utilized in all sorts of electronic equipments such as computers and cellular phones and, among all, application to gate insulator films for semiconductor transistors is a technical field most attracting attention at present. For example, thermal oxide films SiO₂ of silicon have been utilized for current gate insulator films of silicon-based semiconductor transistors.

However, in the existent SiO₂ films, refinement and improvement of performance are going to approach their limit. In modern metal-oxide-semiconductor field effect transistors (MOSFET), the thickness of the gate oxide film has already been reduced to 10 nm or less and it suffers from fatal situation that the leakage current (tunnel current) increases the power consumption of chips. As one of countermeasures, research and development of replacing SiO₂ of gate insulator films at present with high dielectric constant (high-k) materials have been conducted vigorously all over the world. This is because of expectation that the gate capacitance can be increased even at an identical film thickness and, at the same time, that the leakage current can be suppressed by the use of high-k materials.

Oxide materials such as (Ba, Sr)TiO₃, HfO₂, Ta₂O₅ are candidates for such high-k materials but they involve subjects such as degradation at substrate interfaces due to heat annealing during production process and nonstoichiometry and electric miss-matching accompanying therewith. Further, most of the materials involve an essential problem of “size effect” that a relative dielectric constant lowers to increase leakage current as they are reduced in the thickness to a nanolevel with an aim of increasing capacitance.

### DISCLOSURE OF THE INVENTION

### Subject to be Solved by the Invention

In view of the foregoing situations, the present invention has a subject of solving the existent problems, and providing new technical means capable of realizing high dielectric constant and excellent insulating performance simultaneously also in a nanoregion and enabling low temperature production of devices free from degradation for the substrate interface and effect of nonstoichiometry.

### Means for Solving the Subject

As a result of earnest studies for solving the foregoing subjects, the present inventor has found that a single-molecular nanosheet of titanium oxide (titania nanosheet) at a thickness of nanometer (nm) size provides a high dielectric nanomaterial that functions at a nanolevel thickness, and existent problems accompanying heat annealing in the existent semiconductor production process can be solved by preparing device using the nanomaterial as a building block by a self-assembling reaction at room temperature and has accomplished the invention based on the finding.

Then, the single nanosheet and the titania nanosheet as the base for the present invention are concerned with the substance and the production process therefor developed and proposed by the present inventors (JP-A Nos. 2001-270022, and 2004-255684).

The present inventor has made detailed studies on the newly developed titania nanosheets and has found the dielectric property in the nano-sized region that cannot be anticipated at all from existent technical knowledge to reach the invention.

That is, the invention has the following features.

A nano-sized ultrathin film dielectric according to invention 1 has a feature that it comprises a single nanosheet of titanium oxide having a thickness of several atoms, or a laminate thereof.

Invention 2 is an ultrathin film dielectric in the nano-sized ultrathin film dielectric according to claim 1, wherein the length and the width of the single nanosheet is 1 μm to 1 mm.

Invention 3 is a nano-sized ultrathin film dielectric according to invention 1 or 2, wherein the single nanosheet is obtained by exfoliating layered titanium oxide and the layered titanium oxide is any one of those represented by the following formulae (1) to (6) or a hydration product thereof.

CsₓTi_{2-x/4}O₄(0≦x≦1 (1)

Na₂Ti₃O₇ (2)

K₂Ti₄O₉ (3)

Cs₂Ti₅O₁₁ (4)

AₓTi_{2-x/3}Li_{x/3}O₄ (5)

[A is at least one member selected from H, Li, Na, K, Rb, and Cs; (0≦x≦1)]

A_{x/2}Ti_{1-x/2n}M_{x/2n}O₂ (6)

[A is at least one member selected from H, Li, Na, K, Rb, and Cs; M is at least one member selected from Li, Mg, Fe, Ni, Zn, Co, Cr, Mn, Cu, and Al; n is (4-average valance for M); 0≦x≦1]

Invention 4 is a nano-sized ultrathin film dielectric according to any one of inventions 1 to 3, wherein the single nanosheet titanium oxide is titania represented by the following formula (7) or (8).

Ti_{1-δ}O₂(0≦δ≦0.5)( 7)

Ti_{1-x/2n}M_{x/2n}O₂ (8)

[M is at least one member selected from Li, Mg, Fe, Ni, Zn, Co, Cr, Mn, Cu, and Al; n is (4-average valance for M); 0≦x≦1]

Invention 5 is a process for producing a nano-sized ultrathin film dielectric according to any one of inventions 1 to 4, wherein a single nanosheet is coated with no gaps on the surface of a substrate.

Invention 6 is a process for producing a nano-sized ultrathin film dielectric according to invention 5, wherein the process includes dipping a substrate in a cationic organic polymer solution thereby adsorbing the organic polymer to the surface of the substrate, and then dipping the same into a colloid solution in which the single nanosheet is suspended, thereby adsorbing the single nanosheet by electrostatic interaction to each other on the substrate in a self-assembling manner.

Invention 7 is a process for producing a nano-sized ultrathin film dielectric according to invention 6, wherein the substrate is applied with an ultrasonic treatment when it is dipped in the colloidal solution.

Invention 8 is a process for producing a nano-sized ultrathin film dielectric, wherein a laminate of a single nanosheet is formed by repeating any of the process of inventions 5 to 7.

Invention 9 is a process for producing a nano-sized ultrathin film dielectric according to any one of inventions 5 to 8, wherein UV-light is irradiated after lamination of single nanosheets thereby removing the organic polymer.

A nano-sized ultrathin film dielectric device of invention 10 is characterized by disposing up and lower electrodes of nano-sized ultrathin film dielectric according to any one of Inventions 1 to 5.

### BRIEF DESCRIPTION OF DRAWINGS

FIG. 1 is a schematic structural view of a thin film device comprising a laminate type titania nanosheet ultrathin film.

FIG. 2 shows surface observation images by an atomic force microscope in a titania nanosheet ultrathin film of a single layer and lamination layer with a number of lamination layer of 10.

FIG. 3 is a cross sectional TEM image of a laminate type titania nanosheet ultrathin film with the number of lamination layer of 5.

FIG. 4 is a view showing an example of leakage current characteristic of a thin film device comprising laminate type titania nanosheet ultrathin film with the number of lamination layer of 5, 10, and 15.

FIG. 5 is a view showing an example of relative dielectric constant characteristic measured at a frequency of 10 kHz in a thin film device comprising a laminate type titania nanosheet ultrathin film with the number of lamination layer of 5, 10, and 15.

FIG. 6 is a view comparing the dependence of the relative dielectric constant on the film thickness in a laminate type titania nanosheet ultrathin film of the invention and a typical high dielectric constant oxide material, in which an upper view shows comparison in a region of film thickness from 0 to 100 nm and a lower view shows a comparison in a region of film thickness from 0 to 25 nm.

FIG. 7 evaluates shape images and charged state images simultaneously by an atomic force microscope in titania nanosheet single layer film prepared on an Si substrate.

### DESCRIPTION OF REFERENCES

1 lower electrode substrate such as SrRuO₃
2 titania nanosheet as thin flake particles
3 upper electrode such as gold

### BEST MODE FOR CARRYING OUT THE INVENTION

The invention has features as described above and embodiments thereof are to be described below.

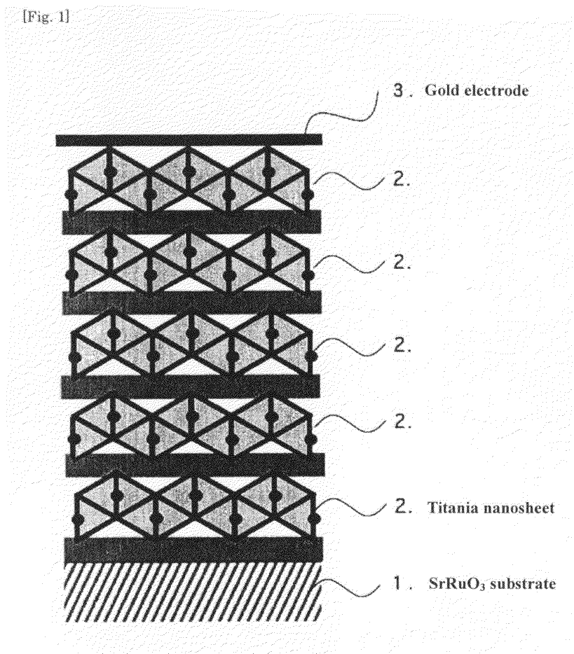

FIG. 1 is a view schematically illustrating a cross sectional structure of a thin film device comprising a laminate type titania nanosheet ultrathin film according to an embodiment of the invention. In FIG. 1, reference 1 shows a lower electrode substrate comprising an atom planar epitaxial SrRuO₃ (hereinafter sometimes simply referred to as “substrate”), and 2 represents a titania nanosheet as a single nanosheet formed on the substrate, and 3 represents an upper electrode formed, for example, of gold.

Then, the embodiment of FIG. 1 illustrates that the titania nanosheet 2 is in a laminated state.

In the invention, a perovskite thin film may also be disposed in the same manner on a metal electrode such as of gold, platinum, copper, and aluminum, a conductive perovskite substrate such as of SrRuO₃ and Nb-doped SrTiO₃, a transparent oxide electrode such as of ITO, Ga-doped ZnO, and Nb-doped TiO₂, and substrate of other types such as Si, glass and plastics not restricted, for example, to the atom planar epitaxial substrate as the lower electrode substrate 1. Also the upper electrode 3 may comprise various types.

The single nanosheet of titanium oxide in the invention is obtained by exfoliating the layer titanium oxide. This is, for example, a titania nanosheet as a constituent layer for a high dielectric constant thin film capacitor (for example, Ti_{0.87}O₂) which is a nano-material having 2-dimensional anisotropy obtained by delaminating a layer titanium compound into a single layer as a basic minimum unit of a crystal structure by a soft-chemical treatment. This is shown, for example, as a nanosheet having a thickness corresponding to the several atoms comprising titania represented by a compositional formula: Ti_{1-δ}O₂ (0<δ<0.5) as a main ingredient. The thickness corresponding to several atoms means a thickness in a range from 0.3 nm to 2.0 nm.

The nano-size ultrathin film dielectric of the invention comprises mainly a single nanosheet of titanium oxide or a laminate thereof, and the single nanosheet may preferably has a particle size with a thickness of about 1 nm, and a length and a width each of 1 μm to 1 mm.

The single nanosheet in this case is obtained being peeled from layer titanium oxide. The layer titanium oxide in this case may be of various types and, preferably includes, for example, the followings.

CsₓTi_{2-x/4}O₄(0≦x≦1 (1)

Na₂Ti₃O₇ (2)

K₂Ti₄O₉ (3)

Cs₂Ti₅O₁₁ (4)

AₓTi_{2-x/3}Li_{x/3}O₄ (5)

[A is at least one member selected from H, Li, Na, K, Rb, and Cs; (0≦x≦1)]

A_{x/2}Ti_{1-x/2n}M_{x/2n}O₂ (6)

[A is at least one member selected from H, Li, Na, K, Rb, and Cs; M is at least one member selected from Li, Mg, Fe, Ni, Zn, Co, Cr, Mn, Cu, and Al; n is (4-average valance for M); 0≦x≦1]

The exfoliation procedure can be referred to as a soft chemical treatment and the soft-chemical treatment is a treatment including an acid treatment and a colloidalizing treatment in combination. That is, when an aqueous acid solution such as hydrochloric acid is in contact with a powder of titanium oxide having a layer structure and the formed product is filtered, washed and then dried, all of alkali metal ions present between layers before the treatment are replaced with hydrogen ions to obtain hydrogen type material. Then, when the obtained a hydrogen type material is put into and stirred in an aqueous solution such as an amine, it is put to a colloidal state. In this case, the layers constituting the layer structure are peeled to every sheet. The film thickness can be controlled within a range from sub nm to nm.

Then, the exfoliated single nanosheet titanium oxide (titania nanosheet) can be in a laminate form according to the alternating self-assembling lamination technique proposed already by the present inventors (JP-A Nos. 2001-270022, and 2004-255684 described above).

That is, the present invention at first proposes, as a method of forming a single layer of a single nanosheet in dielectric or dielectric device, a method of coating a single nanosheet with no gaps on the surface of a substrate and eliminating or decreasing overlaps between each of single nanosheets.

This method discloses, for example, a method of forming a single layer in which means for coating the single nanosheets with no gaps on the substrate surface is conducted by a process of dipping the substrate in a solution of a cationic organic polymer thereby adsorbing the organic polymer on the surface of the substrate and then dipping the same into a colloidal solution in which the single nanosheet is suspended thereby adsorbing the single nanosheet on the substrate in a self-assembling manner by electrostatic interaction, or a method of forming a single layer in which the treating means for eliminating or reducing overlap portions of the single nanosheets to each other is conducted by an ultrasonic treatment in an aqueous alkali solution.

Then, a method of forming a laminate of a nano-sized ultrathin film dielectric including forming a laminate of a single nanosheet by repeating the method described above is also provided.

Further, in the method described above, a method of forming a single layer or a laminate of a nano-sized ultrathin film dielectric is enabled by removing the organic polymer by UV-irradiation.

According to the invention, a process for producing a nano-sized ultrathin film dielectric or a device thereof including the method described above at least as a portion of the steps is realized.

For example, in the embodiment shown in the following examples, a titania nanosheet is prepared by using single crystal of potassium lithium titanate (KₓTi_{2-x/3}Li_{x/3}O₄, x˜0.8) (layer compound) as a starting material and a multi layer film is prepared by an alternating self-assembling lamination technique by way of a cationic polymer on an atom planar epitaxial SrRuO₃ substrate.

It will be apparent that the invention is not restricted by the following example.

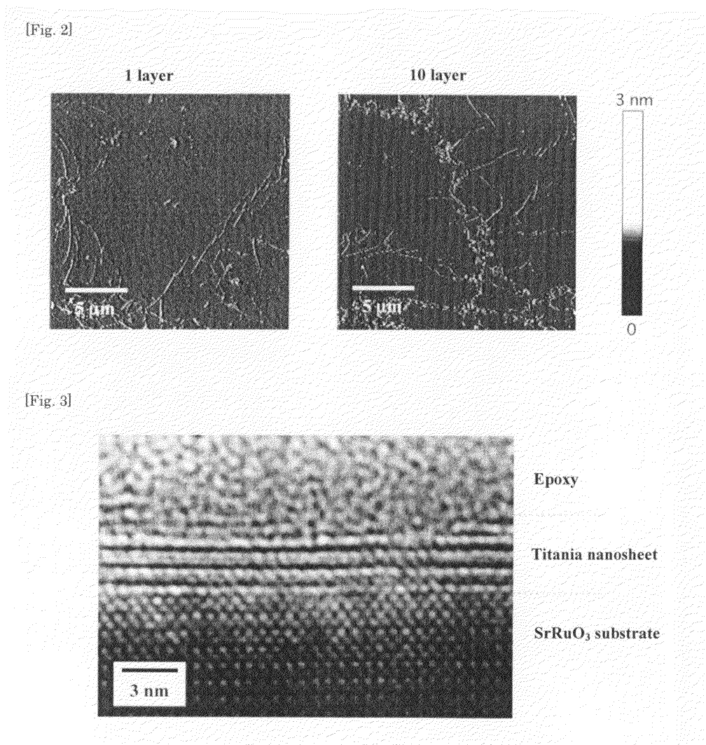

### EXAMPLE

<1> After mixing potassium carbonate, lithium carbonate, titanium oxide, and molybdenum trioxide at a molar ratio of 1.67:0.13:1.73:1.27 and baking them at 1200° C. for 10 hr, they were gradually cooled to 950° C. at a rate of 4° C./hr, potassium molybdate as a flux ingredient was removed in pure water and they were air dried to obtain single crystals of potassium lithium titanate. They were thus obtained. An acid treatment was applied to 30 g of the single crystals in 2 dm³ of 0.5N hydrochroic acid solution at a room temperature to obtain layer titanium acid crystals (H_{1.07}Ti_{1.73}O₄.1.0H₂O) with a size of 100 μm to 1 mm, and then 100 cm³ of an aqueous solution of tetrabutyl ammonium hydroxide (hereinafter referred to as TBAOH) was added to 0.4 g of the layer titanium acid crystals, reacted at a room temperature for two weeks in a settled state to prepare an opaque sol solution in which rectangular nanosheets of about 70 μm length and about 20 μm width represented by the compositional formula Ti_{0.87}O₂ were dispersed. A titania sol solution formed by diluting the sol by 50 times and adjusting pH to 9 was prepared. Further, NaCl in an amount corresponding to 0.5 moldm⁻³ was added to 100 cm³ of 2 wt % solution of polydiallyldimethyl ammonium chloride solution (hereinafter referred to as PDDA solution).

<2> After dipping a conductive substrate as a lower electrode comprising atomic planar epitaxial SrRuO₃ in a solution of: hydrochloric acid: methanol=1:1 for 20 min, a hydrophilic treatment was applied by dipping the same in a concentrated sulfuric acid for 20 min. By subjecting the substrate to a series of operations of (1) dipping to the PDDA solution for 20 min, (2) sufficiently cleaning with Milli-Q pure water, (3) dipping in the stirred titania sol solution described above, (4) sufficiently cleaning with Milli-Q pure water after lapse of 20 min, and (5) applying an ultrasonic treatment for 20 min in an ultrasonic cleaning bath (manufactured by Branson Japan, 42 kHz, 90W) while dipping the obtained ultrathin film to the aqueous solution of TBAOH at pH 11, as one cycle, and a titania nanosheet ultrathin film of a desired thickness was prepared by repeating the cycle for required number of times. UV-light was irradiated by using a xenon light source (4 mW/cm², 48 hr) to the thus obtained titania nanosheet ultrathin film, and a titania nanosheet ultrathin film removed with the organic polymer by utilizing photocatalytic reaction of the titania nanosheet was obtained.

<3> FIG. 2 shows surface observation images by an atomic force microscope (AFM) in the titania nanosheet ultrathin film of a single layer and layers by the number of lamination layer of 10 obtained as described above. It was confirmed from the left part of FIG. 2 that a titania nanosheet ultrathin film which was dense and with smoothness at an atom level coated by the nanosheet with no gaps on the substrate surface was obtained in the single layer titania ultrathin film. The thickness of the titania nanosheet ultrathin film obtained from the AFM observation images is about 1 nm, which substantially agreed with the thickness for 1 nanosheet of a single layer. Further, it was confirmed from the right part of FIG. 2 that the nanosheet was coated with no gaps to the substrate surface and it had a smoothness at the atomic level like the single layer also in the titania ultrathin film with the number of lamination layer of 10. This can be said that an ultrathin film where the single layer nanosheet is laminated layer by layer while maintaining the denseness and the planarity of the single layer nanosheet also in the laminate film.

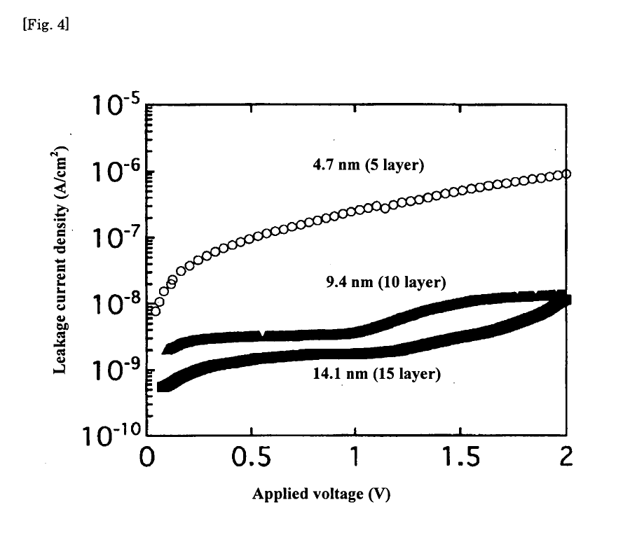

A distinct laminate structure was confirmed also in cross sectional TEM images (FIG. 3) for the laminate type titania nanosheet ultrathin film with the number of lamination layer of 5 manufactured by the same method. In FIG. 3, it should be noted further that in the laminate type titania nanosheet ultrathin film, a low dielectric constant layer or an interface layer attendant to the degradation on the substrate interface and nonstoichiometry by heat annealing in the production process, which caused problem in the existent high dielectric constant oxide materials, are not formed between the lower electrode and the titania nanosheet. This can be said as an epoch-making effect due to the fact that the production step of the laminate type titania nanosheet ultrathin film of the invention utilizes a solution process at a room temperature, which is free from the effect of degradation for the substrate interface and compositional departure.

<4> FIG. 4 and Table 1 show a leakage current characteristic of a thin film device in which a gold electrode was formed as an upper electrode to laminate type titania nanosheet ultrathin films with the number of lamination layer of 5, 10, and 15. Although the film thickness was extremely thin as from 5 to 15 nm, any of the laminate type titania nanosheet ultrathin films showed excellent insulating performance as 10⁻⁷ A/cm² or less. The leakage current when compared with the case of an existent material at a 10 nm film thickness showed extremely excellent insulating performance where the leakage current was suppressed by three order of magnitude relative to existent high dielectric constant oxide materials (Ba, Sr)TiO₃, and rutile type TiO₂.

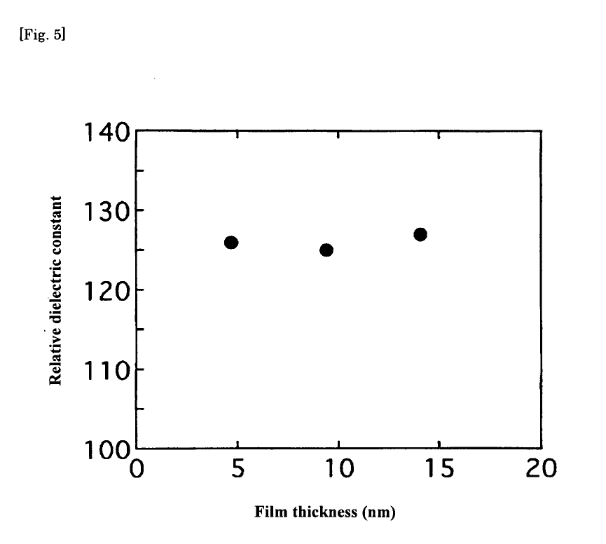

FIG. 5 and Table 1 show the result of measuring the capacitance to laminate type titania nanosheet ultrathin films with a number of lamination layer of 5, 10 and 15 and calculating the relative dielectric constant thereof. As shown in FIG. 5, the relative dielectric constant of the laminate type titania nanosheet ultrathin film showed high relative dielectric constant of 125 irrespective of the number of lamination layer. Since the relative dielectric constant of usual rutile type TiO₂ is from 20 to 60, it can be seen that at least about twice relative dielectric constant was obtained. Further, the dielectric characteristic of the laminate type titania nanosheet ultrathin film shows substantially flat frequency dependency in the range of 1 kHz-10 MHz and it has excellent characteristic with the dielectric loss of 2 to 3% or less.

TABLE 1

| Laminate type titania | | | Relative dielectric |
|---|---|---|---|
| nanosheet ultrathin film | | Leakage current | constant measured |
| Number of | Film | density at application | at a frequency |
| lamination layer | thickness | voltage of 1 V (A/cm_{²}) | of 10 kHz |
| 5 layer | 4.7 nm | 2.33 × 10_{⁻⁷} | 126 |
| 10 layer | 9.4 nm | 3.37 × 10_{⁻⁹} | 125 |
| 15 layer | 14.1 nm | 1.64 × 10_{⁻⁹} | 127 |

While the laminate type ultrathin film comprising the nano-sized titania thin film as the constituent layer can also be manufactured, for example, by a 2-dimensional sol-gel method of applying a sol-gel method to gas-liquid interface in combination with a Langmuir-Blodgett method as the manufacturing technique of ultrathin organic film (K. Moriguchi, Y. Maeda, S. Teraoka, S. Kagawa, J. Am. Chem. Soc. 117 (1995) 1139), a surface sol-gel method of forming an oxide gel film layer-by-layer by hydrolysis reaction of a metal alkoxide with solid surface hydroxyl groups (JP-A No. 2004-299003), etc., such methods require heat treatment and the constituent layer of the obtained nano-sized titania thin film is an anatase type or a rutile type TiO₂ of low specific dielectric constant. On the contrary, the invention has a significant meaning in utilizing the titania nanosheet ultrathin film having a high relative dielectric constant as the constituent layer and it can be said that the excellent dielectric characteristic of the laminate type titania nanosheet ultrathin film of the invention has an epoch-making effect capable of preparing the laminate device in a stable state of the titania nanosheet ultrathin film as it is by utilizing the solution process at a room temperature.

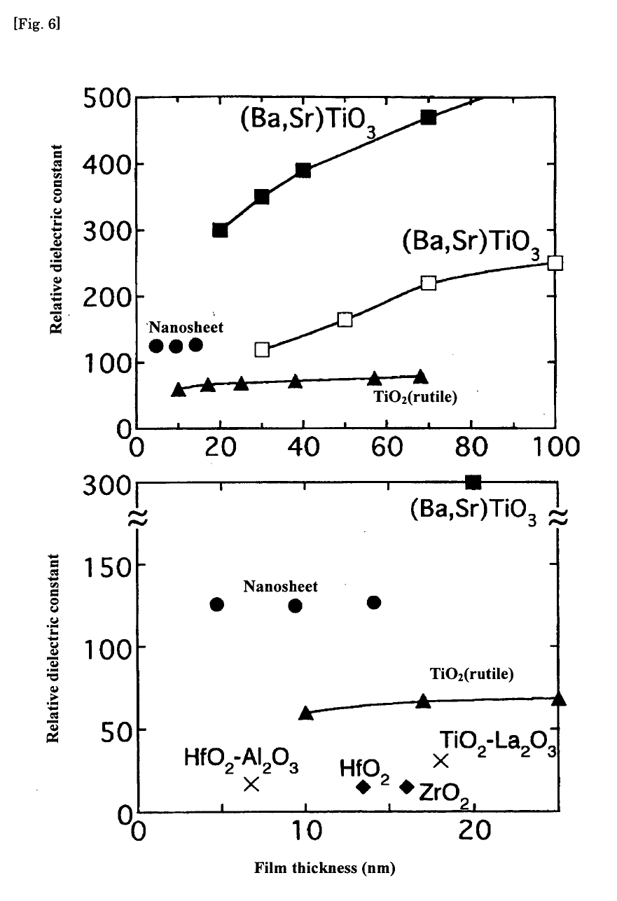

FIG. 6 is a view comparing the dependency of the relative electric constant on the film thickness in the laminate type titania nanosheet ultrathin film of the invention and the existent high dielectric constant oxide materials. In the existent high dielectric oxide materials (Ba, Sr)TiO₃, and rutile type TiO₂, while the relative dielectric constant was lowered when the thickness was reduced to a nanolevel aiming at high capacitance. On the contrary, the laminate type titania nanosheet ultrathin film of the invention was free from the remarkable size effect and showed a relative dielectric constant as high as 125 also in an ultrathin film of about 5 to 15 nm. It is to be noted that the laminate type titania nanosheet ultrathin film of the invention has excellent relative dielectric constant much more excellent over the existent high dielectric oxide materials in an ultrathin film range of 10 nm level. Accordingly, the present invention has an epoch-making effect capable of obtaining a size-free high dielectric constant characteristic capable of attaining high dielectric constant and excellent insulating performance simultaneously also in a nanoregion.

By applying the laminate type titania nanosheet ultrathin film obtained as described above, for example, to gate insulator films for transistors, capacitor components for semiconductor memory devices (DRAM), etc., a capacitor of a capacitance more than several times as high as the existent high dielectric oxide materials can be obtained even at an identical film thickness (high capacitance about twice that of rutile type TiO₂ and about 6 times that of to HfO₂ can be expected at a film thickness of 10 nm). Further, it provides an excellent effect capable of suppressing the leakage current and decreasing of the consumption current, and capable of optionally designing in various forms (such as trench type or attack type) in high degree integration of transistors and semiconductor memory devices (DRAM).

In the foregoing embodiments, while the invention has been described with reference to examples of forming the laminate type titania nanosheet ultrathin film on an atom planar epitaxial SrRuO₃ substrate and applying the same to a gate insulator film or the like, the thin-film capacitor according to the invention is also utilizable by itself as a thin film capacitor.

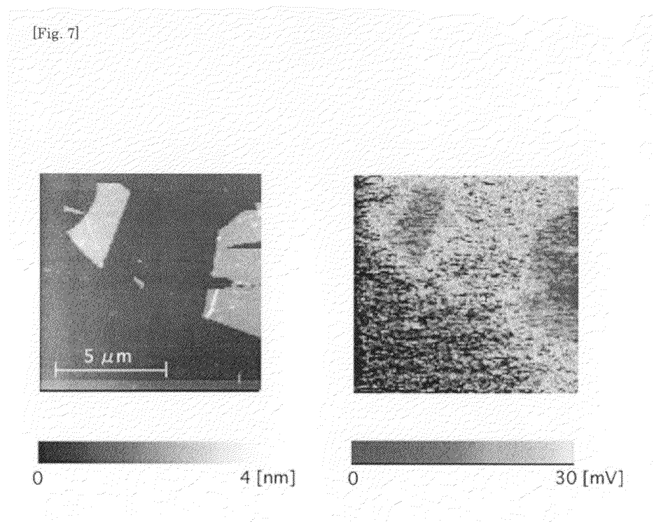

For example, FIG. 7 evaluates the shape images and the charged state images simultaneously by an atomic force microscope for a single titania nanosheet film prepared on a Si substrate. As apparent from comparison between the shape images and the charged state images, the charged state images at a portion of the titania nanosheet showed uniformly grey color and was charged at about 20 mV to the substrate. This shows that the titania nanosheet functions by itself as a thin film capacitor. Further, it can be utilized also to other thin film devices such as thin film sensors or laminate capacitors and can provide the same effect.

### INDUSTRIAL APPLICABILITY

According to the invention as described above, by taking advantage of inherent nano-physical property and high assembling and structural controllability of a titania nanosheet as a two-dimensional nano-structure, high dielectric constant and excellent insulating performance can be realized simultaneously also in the nanoregion. Since the titania nanosheet can produce a device by utilizing a soft chemical reaction such as self-assembling at a room temperature, this can avoid problems such as degradation on the substrate interface and nonstoichiometry by heat annealing in the existent semiconductor production processes and is compatible with various materials.

Further, the invention can attain a low cost and less circumstantial burden process, not requiring large-scaled vacuum apparatus or expensive film deposition apparatus which are predominant in existent semiconductor processes and dielectric thin film processes.

Accordingly, it is concluded that the high dielectric nanomaterial of the invention is extremely useful when it is used in the technical field, for example, electronic materials, IT technical field, and nano-electronics in which gate insulator films for transistors, capacitor components for semiconductor memory devices (DRAM), lamination capacitors for cellular phones and high frequency devices where high dielectric materials are used as basic parts.

1-10. (canceled)

11. A dielectric device having electrodes disposed above and below a film dielectric material in which the film dielectric material comprises a single nanosheet of titanium oxide or a laminate thereof with a thickness in a range from 0.3 nm to 2.0 nm.

12. A dielectric device according to claim 11, wherein the nanosheet of titanium oxide is represented by: Ti_{1-δ}O₂ (0<δ<0.5).

13. A dielectric device according to claim 11, wherein both a low dielectric constant layer and an interface reaction layer are not present between the lower electrode and the nanosheet of titanium oxide.

14. A dielectric device according to claim 12, wherein both a low dielectric constant layer and an interface reaction layer are not present between the lower electrode and the nanosheet of titanium oxide.

15. A process for producing a dielectric device according to claim 11, which includes laminating a nanosheet of titanium oxide by way of a cationic organic polymer above the electrode substrate thereby forming a single layer or a laminate.

16. A process for producing a dielectric device according to claim 12, which includes laminating a nanosheet of titanium oxide by way of a cationic organic polymer above the electrode substrate thereby forming a single layer or a laminate.

17. A process for producing a dielectric device according to claim 13, which includes laminating a nanosheet of titanium oxide by way of a cationic organic polymer above the electrode substrate thereby forming a single layer or a laminate.

18. A process for producing a dielectric device according to claim 14, which includes laminating a nanosheet of titanium oxide by way of a cationic organic polymer above the electrode substrate thereby forming a single layer or a laminate.

19. A process for producing a dielectric device according to claim 15, wherein the electrode substrate is an atom planar oxide electrode substrate.

20. A process for producing a dielectric device according to claim 16, wherein the electrode substrate is an atom planar oxide electrode substrate.

21. A process for producing a dielectric device according to claim 17, wherein the electrode substrate is an atom planar oxide electrode substrate.

22. A process for producing a dielectric device according to claim 18, wherein the electrode substrate is an atom planar oxide electrode substrate.
